(19) United States
(12) Patent Application Publication
(10) Pub. No.: US 2010/0052986 A1
(43) Pub. Date: Mar. 4, 2010

(54) COHERENT COMBINING FOR WIDELY-SEPARATED APERTURES

(75) Inventors: Richard J. Nink, Melbourne, FL (US); Thomas R. Oliver, Melbourne, FL (US); G. Patrick Martin, Merritt Island, FL (US); Mark Lawrence Goldstein, Melbourne, FL (US); H. Richard Phelan, Palm Bay, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/203,592

(22) Filed: Sep. 3, 2008

(51) Int. Cl. H01Q 3/00

(52) U.S. Cl. 342/372

(57) ABSTRACT

Method for coherently combining signals received from two widely separated antenna apertures (204, 206). The method includes positioning a first antenna aperture (204) at a first location spaced apart a distance with respect to a second location of a second antenna aperture (206). A distance between the first antenna aperture and the second antenna aperture is selected to be at least a plurality of wavelengths at a predetermined operating frequency of the first antenna aperture and the second antenna aperture. An antenna beam or pattern (208, 210) from each antenna aperture (204, 206) is directed toward a target (212) positioned at a location remote from the first antenna aperture and the second antenna aperture. Adaptive digital processing (416) is then used to coherently combine the signals independently received by each aperture from the common source.

### BACKGROUND OF THE INVENTION

1. Statement of the Technical Field

The inventive arrangements concern wireless communications systems and more particularly systems that make use of multiple antenna apertures that are widely separated by many wavelengths.

2. Description of the Related Art

Antennas are commonly used for receiving and transmitting RF energy from a remote source. One or more elements comprising an antenna can define an antenna aperture. The antenna aperture can be thought of as a physical area within which incoming RF radiation is captured by the antenna and communicated to a load. The element or elements which define the antenna aperture can be as simple as a single dipole element or as complex as a phased array comprising multiple antenna elements.

Phased arrays are useful for many applications because they provide a means for electronically steering an antenna beam rapidly in any direction. However, phased array antennas incur a significant loss in signal gain as they steer off toward the edges of their field of view. This so called scan loss results in an increasing loss of antenna gain as the beam is electronically steered at increasing angles with respect to antenna broadside. For this reason, it is often desirable for a particular platform such as a ship or airplane, to use multiple phased arrays. For example, the multiple phased arrays can be physically pointed in different relative directions to provide a means for receiving signals from a wider range of angles. Also, each antenna array can define a separate antenna aperture.

A loss of gain on the order of 3 dB or more can result when antenna beams associated with two orthogonal phased array panels are each steered to the mid point between the panels. To compensate for this loss, conventional architectures often increase the size of the phased array or provide additional phased array panels at intermediate angles to overlap the full-gain scan area. Still, it will be appreciated that more array panels or more array elements will result in an increased cost.

When multiple antenna apertures are located in close proximity to one another, the signals from each array panel can be combined with relative ease. However, various practical considerations can prevent such a closely situated mounting arrangement. Consequently, it may be necessary to position each antenna aperture at a location on a platform which is widely spaced from the other apertures. Depending on the operating frequency, this could mean that the various apertures are spaced hundreds, thousands, or even tens of thousands of wavelengths apart from one another. For example, in the case of a ship, a first antenna aperture could be located on a port side of the ship; a second antenna aperture could be provided on a starboard side of a ship; and a third antenna aperture could be located on a forward portion of the superstructure.

When widely spaced antenna apertures are necessary, it is common for each individual aperture to be operated independently of the other apertures. In such cases, it can be necessary to transition from using a first aperture to a second aperture as a target moves relative to a platform on which the antenna system is based. Still, such a switched approach can be problematic as there can be a loss of data when switching between apertures.

Other conventional techniques for multiple widely spaced apertures can prevent momentary loss of data. For example some systems have utilized a baseband or post-demodulation soft-level decision combining process that compares information bits received from each antenna aperture. The system then makes a decision as to which bits are correct. However, these techniques also have some problems. One limitation of such systems is that they are hardware intensive. For example, they generally require a complete modem implemented for each aperture. Another disadvantage is that such systems are known to suffer from a reduction in G/T (G/T is a characterization of antenna performance, where G is the antenna gain in dB (decibels) at the receive frequency, and T is the equivalent noise temperature of the receiving system in Kelvin). The reduction in G/T increases the further an aperture scans prior to the adjacent aperture taking over, resulting in 3 dB reduction in G/T for a 4 panel system. This performance disadvantage leads to less link margin for the communication system, especially when trying to acquire a communication signal at maximum scan angles.

Accordingly, there remains a need to coherently combine widely spaced apertures on various platforms in a way that avoids scan loss. There is also a need to coherently combine signals from multiple widely spaced apertures in a way that provides a smooth aperture to aperture transition so as to avoid a switched transition. It would also be desirable to provide a method for coherently combining 2 or more widely separated apertures to maximize a signal to noise ratio.

### SUMMARY OF THE INVENTION

BSS algorithms are conventionally used for separating two spatially independent signals received at a single antenna aperture. The invention uses a BSS algorithm in a unique way to instead provide a method for coherently combining signals received from two or more widely separated antenna apertures. The method begins by positioning a first antenna aperture at a first location spaced apart a distance with respect to a second location of a second antenna aperture. A distance between the first antenna aperture and the second antenna aperture is selected to be at least a plurality of wavelengths at a predetermined operating frequency of the first antenna aperture and the second antenna aperture. For example, the distance can be greater than 100 wavelengths at the predetermined operating frequency. Alternatively, the distance can be chosen to be greater than 1000 wavelengths at the predetermined operating frequency.

An antenna beam or pattern from each antenna aperture is directed toward a target positioned at a location remote from the first antenna aperture and the second antenna aperture. Adaptive digital processing is then used to coherently combine the signals independently received by each aperture from the common source. More particularly, the signals are coherently combined in an adaptive process which eliminates a large aperture effect caused by the distance between the first and second antenna apertures. For example, the adaptive process includes eliminating at least one large aperture effect, such as keeping the resultant main beam with its very narrow main beam, deep nulls, and numerous grating lobes precisely on target. The narrow beam will not fall off target resulting in pointing an adjacent null at the target. This results in a much easier tracking solution for the tracker.

According to one aspect of the invention, the adaptive process is a blind source separation (BSS) algorithm. The method also includes generating an optimal steering vector for at least one of the first and second antenna apertures using the adaptive process. Notably, the optimal steering vector is actually determined based on the weighting factors generated by the BSS since it is obtained from the antenna response, and it's a perfect conjugate match.

The adaptive process referred to herein can include calculating at least one complex weight responsive to the common RF signal received at the first antenna aperture and the second antenna aperture, and applying the at least one complex weight to an output signal produced by at least one of the first antenna aperture and the second antenna aperture. Once the complex weighting has been applied to the signals from at least one of the antenna apertures, the signals from each aperture can be summed together to form a combined signal.

The antenna apertures described herein can include a phased array. In that case, the method can also include combining RF signals received by a plurality of elements from a single source for prior to performing the coherently combining step. Moreover, the step of directing the antenna beams from each aperture toward the target can include selectively controlling a plurality of elements forming the phased array to electronically scan at least one of the first antenna beam and the second antenna beam.

According to an alternative embodiment, the invention includes a system for combining RF signals from a two or more widely separated apertures. The system includes a first antenna aperture positioned at a first location, and at least a second antenna aperture positioned at a second location spaced apart a distance with respect to the first location.

An antenna position controller is provided for directing toward a remote target at least a first antenna beam defined by the first antenna aperture and a second antenna beam defined by the second antenna aperture. A signal processing system is provided for coherently combining an RF signal received from a common target at the first antenna aperture and at least the second antenna aperture in an adaptive process. The adaptive process is designed to eliminate a large aperture effect caused by the distance between the first and second antenna apertures.

According to an embodiment of the invention, the adaptive process is a blind source separation algorithm (BSS). The signal processing system also generates an optimal steering vector. The optimal steering vector is used to control the first and second antenna apertures.

The signal processing system is further configured for generating a time difference control signal. The time difference control signal can be determined based on a time of arrival difference information of the RF signal at the first antenna aperture and at least the second antenna aperture. At least one time delay device is provided responsive to the time difference control signal for time aligning the RF signal as received at the first antenna aperture and at least the second antenna aperture.

A plurality of complex weight memories are provided, coupled to the processing means, for storing a plurality of complex weights generated by the BSS algorithm. Further, at least one multiplier is provided coupled to an output of the time delay device and the complex weight memory. The multiplier applies the complex weights to the RF signal received from the common source. The system further includes a summing device coupled to each of the multipliers for summing an output of each multiplier subsequent to applying the complex weights.

### BRIEF DESCRIPTION OF THE DRAWINGS

FIG. 1 is a drawing which is useful for understanding how radar apertures can be displaced some distance apart on a platform.

FIG. 2 is a drawing that is useful for understanding the affect upon the antenna beams formed by each of the apertures in FIG. 1 when the two antenna beams are directed toward a common target.

FIG. 3 is a drawing that is useful for understanding a problem which occurs when apertures are widely spaced as shown in FIG. 1.

FIG. 4 is a block diagram that is useful for understanding an implementation of a coherent combiner for use with widely spaced antenna apertures.

### DETAILED DESCRIPTION OF THE PREFERRED EMBODIMENTS

It is known that a variety of blind source separation (also referred to as blind signal sorting or “BSS”) algorithms can be used to recover a desired individual signal from a composite signal including the desired signal together with one or more other signals from different sources, including noise. The BSS algorithm is commonly used in such situations because the separation of signals must be performed with little or no information about the nature or source of the various signals. A variety of known BSS algorithms provide conventional solutions to this problem. These techniques generally include methods that are based on second-order statistics, and those which are based on higher-order statistics.

From the foregoing, it will be understood that BSS algorithms are well known in the art. However, it should also be recognized that such BSS algorithms are conventionally applied to problems which involve separating signals received at a single antenna aperture from two or more spatially independent sources. In this context, it should be understood that the term antenna aperture refers to a single antenna element (such as a large reflector antennas), or an array of closely spaced elements comprising a phased array panel (where inter-element spacing is typically less than about one wavelength).

In contrast, the present invention uses a BSS algorithm in a novel way. Rather than applying a BSS algorithm to separate signals received at a single antenna aperture from two or more spatially independent sources, the BSS algorithm is instead used to coherently combine a signal from a single source but received from two or more widely separated antenna apertures. This novel use of a BSS algorithm has important applications to a variety of systems where it is desirable or necessary to rely on multiple antennas at locations that are widely separated (for example, where apertures are separated by hundreds, thousands or even tens of thousands of wavelengths). Examples of such systems include without limitation various terrestrial antenna arrays for deep space study, ship-board systems, and even space vehicle systems.

The invention will now be described more fully hereinafter with reference to accompanying drawings, in which illustrative embodiments of the invention are shown. This invention, may however, be embodied in many different forms and should not be construed as limited to the embodiments set forth herein. For example, the present invention can be embodied as a method, a data processing system, or a computer program product. Accordingly, the present invention can take the form as an entirely hardware embodiment, an entirely software embodiment, or a hardware/software embodiment.

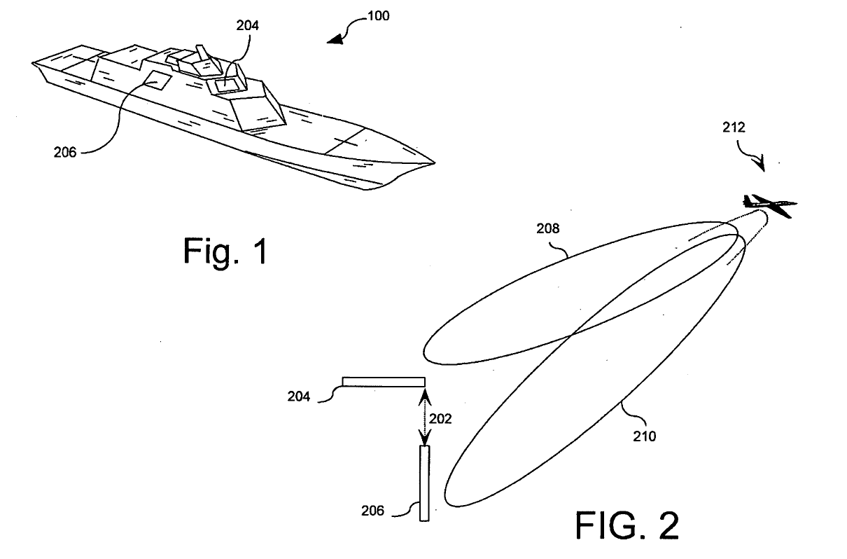

FIG. 1 is a drawing that is useful for understanding how antenna apertures can be widely displaced apart on a platform 100. As will be appreciated by those skilled in the art, an antenna aperture is a defined area for receiving incoming radiation where radiation passing within the area is delivered by an antenna to a load. In this regard, it should be understood that the exact nature of the antenna which is used is not critical for the purposes of the present invention. Each antenna which defines an antenna aperture can be comprised of a single antenna element, such as a reflector type antenna. A direction of maximum gain for an antenna pattern associated with such antennas can be modified by mechanically re-orienting the position of the antenna. Such systems are well known in the art. Alternatively, each antenna aperture can be comprised of a phased array which includes two or more antenna elements. In a phased array antenna, it is conventional to electronically control a direction of an antenna pattern associated with the phased array by controlling a set of complex weights that are applied to the outputs of each of the individual antenna elements which comprise the array. This process is conventionally known as scanning.

As shown in FIG. 1, a platform 100 can be used to support a plurality of antenna apertures 204, 206. In FIG. 1, the platform 100 is shown to be a ship, but it should be understood that the invention is not limited in this regard. The platform 100 can be a stationary land based platform, or it can be any type of vehicle on which it is necessary or convenient to locate antenna apertures 204, 206 at locations that are widely spaced apart.

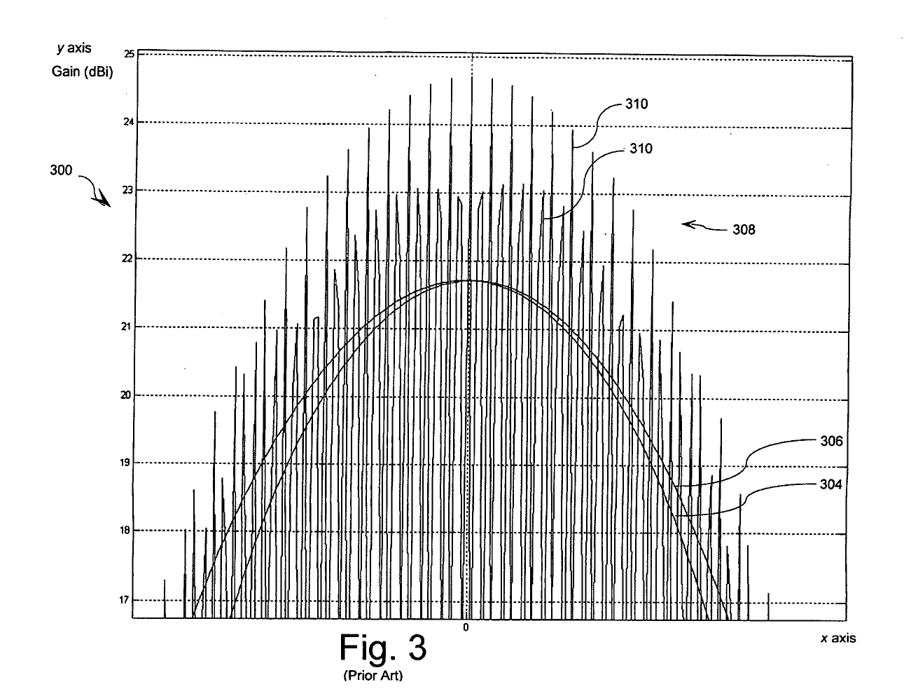

The term “widely spaced apart” as used herein means a distance between two antenna apertures which will necessarily result in an interference pattern when the two apertures are combined using conventional additive means. This concept is described in greater detail in relation to FIG. 3. However, it can be understood that the term “widely spaced apart” refers to a pair of antenna apertures that are spaced apart by a distance “d” which is at least greater than one wavelength at the operating frequency of each of the antenna apertures 204, 206. Still, from a practical standpoint, it should be understood that the inventive arrangements are intended to solve a problem of aperture combining in which the antenna apertures are located spaced apart at distances which are much greater than one wavelength. For example, in practical applications, the term “widely spaced apart” will generally indicate that two apertures are spaced apart by a distance “d” which is on the order of hundreds, thousands, or tens of thousands of wavelengths apart in distance.

Finally, it may be noted that only two antenna apertures 204, 206 are shown in FIG. 1. In this regard, the invention will be described with respect to a system which includes only two apertures. However, it should be understood that the invention is not so limited. Instead, the inventive arrangements described herein are scalable so that the methods and system can also be used with three or more antenna apertures.

Referring now to FIG. 2, there is provided a drawing that is useful for understanding the antenna patterns formed by each of the apertures 204, 206. As can be observed in FIG. 2, each of the antenna apertures 204, 206 defines a directional antenna pattern 208, 210. A direction of maximum gain for these antenna patterns can be controlled by mechanical and/or electronic steering systems (i.e. a scanned beam). In FIG. 2, the antenna patterns 208, 210 are controlled so that the portion of each pattern exhibiting maximum gain is generally oriented in a direction associated with a target 212. There are a variety of conventional methods which can be used for this purpose. For example, the system can rely upon a priori knowledge about an anticipated location of a target in order to direct an antenna beam from each aperture in the general direction of the target. Alternatively, targeting radar can be used to located and convey information regarding the location of the desired target for the purpose of pointing the beams from each aperture. As yet another alternative, a conventional antenna control unit (ACU) with a basic scanning capability can be used to locate a target and direct the broad beams from the aperture antennas. Still, the invention is not limited to any of the foregoing methods and any other suitable method can be used to control the apertures.

Referring now to FIG. 3, there is shown a drawing that is useful for understanding a problem which occurs when summing the output signals from apertures which are widely spaced. FIG. 3 is a plot 300 that shows a first antenna pattern 304 for a first aperture, and a second antenna pattern 306 for a second antenna aperture. The sum pattern 308 represents the combined sum of RF energy received from a common target by a pair of widely spaced apertures. For convenience, it can be assumed that each antenna is oriented so that a boresight angle (0 degrees) for each antenna is oriented in the same general direction.

In FIG. 3, the x axis represents an angle of a source of RF energy relative to a boresight angle (e.g. azimuth). The y axis represents the amplitude of the combined signal received from a common target after the signals from the two widely spaced antenna apertures are summed. Depending on the particular azimuth relative to boresight, the two signals 304, 306 from the two widely spaced apertures will add or subtract with respect to each other, resulting in the sum pattern 308 as shown. The signals 304, 306 will add or subtract depending upon the relative phase of the signals after they are communicated to a common location where the two signals are summed. The relative phase as between the two summed signals will also vary depending on the position of a target or RF source relative to a boresight angle of each aperture. The resulting sum pattern 308 will be an interference pattern which is apparent from the series of narrow spikes 310 which are present in the pattern. Notably, the individual spikes 310 become increasingly narrow as the distance between the two apertures is increased.

Those skilled in the art will readily appreciate that the sum antenna pattern 308 in FIG. 3 is of limited usefulness when attempting to receive a signal from a remote target. The spikes 310 can be understood to mean that the antenna has significant gain within a plurality of very narrow angular ranges defined by the peaks of each spike. Between these angular ranges where the peaks of the spikes are located, the sum pattern has sharp nulls where the sum pattern exhibits little or no antenna gain. This leads to difficulty if one is attempting to receive signals using the sum antenna pattern 308. If the target is located in one of the nulls defined by the sum pattern 308, the received signal will be significantly attenuated. Conversely, it can be very difficult to control the individual widely spaced antenna apertures so that the target remains in the peak of one of the spikes.

Moreover, the numerous spikes and nulls can lead to ambiguity with regard to determining the angle relative to boresight where the target is located within the sum beam. In order to reduce such ambiguity, there must be tight control over the electrical length and phasing of the transmission lines from each of the apertures to the location where the signals are summed. Even so, electrical length of cables can change with temperature and cable flex. It should also be appreciated structural flexure of the ship can cause variations in the distance between antenna apertures, resulting in a net phase or amplitude variation.

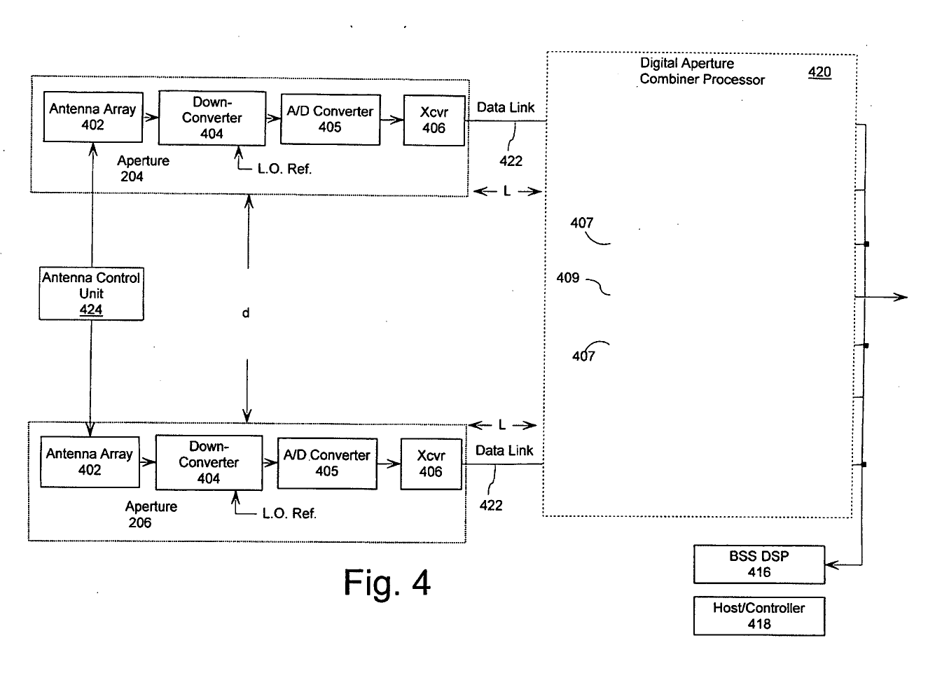

FIG. 4 is a block diagram that is useful for understanding an implementation of a coherent combiner for use with widely spaced antenna apertures 204, 206. The widely spaced antenna apertures can be mounted on any suitable platform, such as a aircraft, ship, or fixed installation. The widely spaced antenna apertures are spaced apart by a distance “d”. For example, the distance “d” can be 30 meters in one embodiment of the invention. Further, it should be noted that only two apertures are shown in FIG. 4. However, the invention is not limited in this regard. The inventive arrangements described herein can be implemented in systems that involve three or more widely spaced apertures.

As can be observed in FIG. 4, apertures 204, 206 in this example are each comprised of an antenna array 402. Antenna arrays 402 in this example are phased arrays comprising a plurality of elements. For example, each antenna array 402 can be comprised of 64 individual antenna elements which are combined together at the location of the array. Complex weights can be used to combine RF signals received by the individual antenna elements so as to form a phased array which can be electronically scanned. Phased array antennas of the kind described herein are well known in the art. Still, it should be understood that the invention is not limited in this regard, and the antenna arrays 402 can have alternative arrangements. For example, each antenna array 402 can also be a reflector type antenna such as a parabolic dish antenna.

The individual antenna arrays 402 can be selectively controlled so that they form antenna patterns that are generally pointed toward a target 212. The means for directing the antenna patterns or beams towards a target can include a conventional antenna control unit (ACU) 424. The precise arrangement of the ACU will vary depending on the type of antenna array which is used. For example, a phased array would require different control signals as compared to a parabolic reflector type antenna. However, such ACU systems are well known in the art. Regardless of the specific antenna array used, the ACU 424 can direct the antenna patterns in the approximate direction of the target using conventional techniques.

According to one embodiment of the invention, the signals received by the antenna array can be signals in the microwave range. Because of practical limitations with regard to A/D converters, it can be desirable to convert these microwave signals to a somewhat lower frequency, which is more suitable for conversion from an analog signal to a digital signal format. Accordingly, in an embodiment of the invention, each aperture 204, 206 includes a respective down-converter 404 for converting an RF signal received by each antenna array 402 to a lower frequency. For example a conventional analog mixing arrangement can be used for this purpose in conjunction with a local oscillator (not shown).

Down-converters are well known in the art and therefore will not be described in detail herein. However, it should be appreciated that in order to provide a stable reference for phase information, a local oscillator signal used in the down-converter 404 of each aperture 204, 206 is preferably phase locked relative to the local oscillators in each of the other antenna apertures. There are a variety of methods by which this can be accomplished. For example, each of the local oscillators can be phase locked with respect to a common reference signal. According to one embodiment, the common local oscillator reference signal (L.O. Ref.) can be provided to each down-converter 404 from the digital aperture combiner processor 420 by means of data link 422. Still, the invention is not limited in this regard.

In each aperture 204, 206 the output from each of the down-converters 404 is communicated to an A/D converter 405. The A/D converter 405 for each aperture converts the down-converted RF signal from an analog format to a digital format. The A/D converters 405 provided for each aperture 204, 206 utilize conventional techniques to generate a digital data stream comprising I and Q data. As will be understood by those skilled in the art, the I and Q digital data stream is a real time digitized representation of the phase and amplitude of the signals received by each aperture 204, 206. A/D converters capable of performing this conversion are well known in the art. However, it should be understood that the details associated with the A/D conversion process, such as the required dynamic range and sampling rate, will depend on the nature of the signals being converted and the required bandwidth of the system. According to one embodiment, the A/D converter can be designed to support high data rate signals. For example, the A/D converter can have a sampling rate which is sufficiently high so as to support a 375 MHz data bandwidth (corresponding to a data rate of 274 Mega bits-per-second).

Each aperture 204, 206 also includes a data transceiver 406 which is suitable for communicating wideband digital data from the A/D converter, over a relatively long data link 422, to an interface 408. For example, the data link 422 can have a length “L” which can be as long as 100 meters to accommodate a distance between an antenna aperture 204, 206 and a digital aperture coherent processor 420.

According to an embodiment of the invention, the A/D converter 405 and the data transceiver 406 can be combined in a single device. The A/D converter 405 and data transceiver are advantageously be located near an antenna aperture 204, 206. According to one embodiment, the data transceiver includes an optical transmitter for communicating data over the data link 422 to the interface 408. The output of this optical transmitter is a Digital IF (VITA 49) signal, moving over a fiber-optic connection to a signal processing subsystem (digital aperture combiner processor 420) located up to 100 meters away. Still, it should be understood that the invention is not limited in this regard and any other suitable arrangement can be used for implementing the A/D converter 405 and the data transceiver 406.

Referring again to FIG. 4, digital data from each aperture 204, 206 is communicated to the digital aperture combiner processor 420. The digital data from each aperture 204, 206 is respectively received at interfaces 408. If data link 421 is an optical data link, then interfaces 408 are advantageously selected to be fiber-optic type interface devices. In this regard, it will be appreciated that optical data links are particularly well suited for use in the inventive arrangements due to their ability to communicate large amounts of data at high rates.

The digital data for apertures 204, 206 received at each interface 408 is continuously provided to time delay device 410. The amount of time delay which must be implemented by time delay devices 410 is relatively large and will generally depend upon the amount of separation of the apertures relative to each other.

Periodically, the digital data stream received from apertures 204, 206 at each interface 408 is also communicated to a respective memory 412. This process is advantageously performed concurrently for the digital data received from each aperture. In this way, a set of data can be obtained which is representative of the current signals that are being received by each aperture 204, 206. The periodic rate at which this digital data stream is sampled can depend upon the rate of change associated with position of targets which are being tracked. According to one embodiment, the periodic sampling can occur at some rate which corresponds to the tracking updates performed by the ACU. This rate will generally be at least once per second. Typically one or two milliseconds of data will provide a sufficient amount of data.

The digital data which is periodically communicated to a respective memory 412 provides a set of sample data upon which a blind source separation algorithm can perform BSS processing in (BSS) DSP 416. In a conventional BSS application, a plurality of sensors (individual antenna elements comprising an array) is used to receive different mixtures of source signals from a number of different sources. In this regard, the output of each sensor can be understood to be a mixture of the source signals. Notably, the mixture of source signals from each sensor will be a unique sum of the source signals. Samples of signals received at each sensor are used to populate a mixing matrix. Each sensor provides a set of inputs to the mixing matrix. The mixing matrix is then processed using the BSS algorithm in order to separate the desired source signal from the mixture of source signals. For example, some BSS techniques determine array weights for the mixing matrix by attempting to minimize the mean squared errors due to both interference emitters and Gaussian noise, thereby maximizing the signal to noise (S/N) ratio.

In contrast to the foregoing conventional application of a BSS algorithm, the BSS algorithm in the present invention uses source signals from each of the widely spaced antenna apertures to create a mixing matrix, which is then used to calculate a set of complex weights. However, in this case, the BSS algorithm is not used to separate the desired source signal from the mixture of source signals. Instead, the complex weights are calculated for each digital data stream received from each aperture, so that the correlation energy is maximized when the complex weights are applied and the signals from the two apertures are combined. The complex weights include phase and amplitude weights. The complex weights calculated by the BSS DSP processor 416 are communicated to each of the complex weight memories 414.

As noted above, the digital data stored in each memory 412 is also communicated to a respective time delay device 410. Time delay devices 410 each provide a time delay which selectively delays the communication of the digital data stream to multipliers 407. The time delay devices 410 provide a mechanism for time aligning the digital data received from apertures 204 and 206. In particular, the time delay devices 410 are used to time-align the digital data-stream samples from each of the apertures to a high degree of accuracy. For example, the time delay devices are preferably arranged so that they are capable of time-aligning the digital data stream samples from apertures 204, 206 with a level of accuracy which is at least within 3.6 pico-seconds. Still, the invention is not limited in this regard.

The time delay devices 410 are an important aspect of the digital aperture combiner 420. The time-alignment of the digital data stream samples from each aperture 204, 206 is necessary because the BSS algorithm provides complex weights for adjusting phase and magnitude, but not time. Even if phase and magnitude weight are optimized, maximum correlation energy will not be obtained if the digital data streams from apertures 204, 206 are not time aligned.

Each antenna aperture 204, 206 has an independent geometry and an associated time delay that directly corresponds to the spatial relationship between the antenna aperture 204, 206 the other antenna aperture (or apertures) 204, 206, the digital aperture combiner 420, and the target 212. In this regard, it will be understood that an optimal time delay for achieving maximum correlation energy from the digital data streams generated by two or more widely separated apertures 204, 206 will continuously vary as a position of a target 212 is changed. In order to ensure successful combining operations, the time delays for each antenna aperture 204, 206 must be continuously updated as the spatial relationship between each aperture 204, 206 and target 212 changes.

Since each aperture is widely separated from the other aperture(s), the time that it takes the signal to travel from the source to the aperture is different for each aperture. This difference in time-of-arrival is the basis for determining a time delay control signal used to control the time delay device 410. The time delay device 410 for each aperture 204, 206 responds to a respective time delay control signal to time-align the digital data stream for that aperture. Following is a more detailed explanation of the calculations required for determining a time delay specified by a time delay control signal for controlling each time delay device 410.

The time that it takes a signal to travel from the source to the antenna aperture is found by dividing an aperture's distance to target in meters (m) by the speed of light in meters/second (m/s):
source_to_aperture_{—}1_time=source_to_aperture_{—}1_distance (m)/speed_of_light (m/s)
source_to_aperture_{—}2_time=source_to_aperture_{—}2_distance (m)/speed_of_light (m/s)
source_to_aperture_N_time=source_to_aperture_N_distance (m)/speed_of_light (m/s)
   Distance to target data is obtained by any one of a variety of different methods. For example, the distance to target information can be calculated by using real time location information provided by the target (i.e. position data) communicated as part of a digital data stream, by using a predetermined set of tracking information to determine where a target will be at a particular time, or by using location information provided by a tracking radar. Still, the invention is not limited in this regard, and any other suitable technique can be used for this purpose. Once the source_to_aperture_X_time values for all apertures have been obtained, they can be scaled so as to represent only the difference in time-of-arrival for signals arriving at different apertures. In particular, the difference in time-of-arrival can be calculated to ensure that all time delays are positive so that they can be functionally realized as follows:
aperture_{—}1_delay=max(source_to_aperture_x_time)-source_to_aperture_{—}1
aperture_{—}2_delay=max(source_to_aperture_x_time)-source_to_aperture_{—}2
aperture_N_delay=max(source_to_aperture_x_time)-source_to _aperture_N
   In the foregoing calculations, the max(source_to_aperture_x_time) is the maximum calculated time that it takes a signal to travel from the source to any one of the antenna apertures. The various calculations described herein can be performed in BSS DSP 416. However, the invention is not limited in this regard.

These aperture_X_delay times for each aperture 204, 206 are communicated to each time delay device 410. For example, this information can be communicated in the form of a control signal. The time delay devices 410 are responsive to this control signal to delay the data stream from each antenna aperture by a specified amount. Time delay devices are well known in the art. Accordingly, time delay devices 410 will not be described in detail. However, it should be understood that since the time delay is implemented in a digital system, the time delay is converted to a sample delay:
aperture_X_sample_delay=aperture_X_delay/sample_period
   where X signifies the matrix of aperture delays. For example, if the sampling rate is 1.1 GHz, then the sample_period=1/(1.1 GHz)=909 ps. According to a preferred embodiment, the time delay devices 410 implement the aperture_X_sample_delay in two steps. The integer part of the sample delay is implemented in delay devices 410 using a conventional delay-line. In contrast, the fractional part of the sample delay is preferably implemented in delay device 410 using a conventional interpolation filter as would be known to one skilled in the art. For example, the interpolation filter can be selected so that it is capable of shifting to a resolution of 1/256 of a sample. If the sample period is 909 ps, then this would provide a time shifting resolution of =909 ps/256=3.5 ns.

From the foregoing disclosure, it will be understood that the time delay 410 can selectively delay the arrival of the digital data at multiplier 407. Following such delay, the digital data stream is communicated to each of the multipliers 407 from a respective time delay unit 410. The I and Q components of the digital data stream are communicated to the multipliers 407 and multiplied by a set of complex weights provided by complex weight memories 414. The digital output of each of the multipliers 407 is thereafter communicated to the summing device 409 which sums the complex I and Q outputs from each of the multipliers. The I and Q output from the summing device is a complex signal comprised of I and Q components which is the coherent combination of the RF signals received from aperture 204 and 206. Significantly, the coherently combined signal will have none of the undesirable characteristics associated with conventionally summed signals from widely spaced apertures.

The host/controller 418 is provided for facilitating configuration of the system shown in FIG. 4. The host/controller 418 can support a user interface which is responsive to user inputs for configuring the operation of one or more elements comprising the digital aperture combiner processor 420, and each aperture 206. In this regard, it will be understood that the host/controller can have one or more data or communication links with each of these elements. In FIG. 4, these communications and control lines are omitted for greater clarity.

The signal processing and control functions associated with the present invention can be realized in one computer system. Alternatively, the present invention can be realized in several interconnected computer systems. Any kind of computer system or other apparatus adapted for carrying out the methods described herein is suited. A typical combination of hardware and software digital signal processing equipment, and/or a general-purpose computer system. The general-purpose computer system can have a computer program that can control the computer system such that it carries out the methods described herein.

According to a preferred embodiment, the digital aperture combiner processor 420 can be implemented using FPGA technology. The BSS DSP 416 can be implemented using utilizing any suitable high speed computer processing system programmed with an appropriate set of instructions, and capable of carrying out the inventive arrangements described herein. Still, it will be understood by those skilled in the art that the invention is not limited in this regard, and any other suitable hardware arrangement can also be used.

The implementation of the BSS DSP 416 will now be discussed in further detail. It is well known in the art that a variety of blind source separation (BSS) techniques can be used to recover a desired individual signal from a composite signal which typically includes the desired signal together with one or more other signals. The phrase “blind source” is commonly used in such situations because the separation of signals must be performed with little or no information about the nature or source of the signals. As will be understood by those skilled in the art, there are a variety of conventional BSS algorithms which have been published for solving the problem of separating signals in these types of situations. These techniques generally include methods that are based on second-order statistics, and those which are based on higher-order statistics.

In the present invention, a BSS algorithm is not used to separate spatially independent signals arriving at a single aperture from two or more independent sources. Instead, the BSS algorithm is used to determine a set of weights which produce maximum correlation energy for a signal from a single source which has been received at n widely separated apertures (in FIG. 4, n=2). In this regard, the present invention represents a novel use of a BSS algorithm. In particular, the BSS algorithm is used for coherent combining of n widely separated apertures. The BSS algorithm determines a set of optimum weights to maximize energy from two or more apertures 204, 206 which are separately pointed at a common source.

According to one embodiment of the invention, the BSS algorithm is a second-order cumulant matrix pencil algorithm. Such BSS algorithm is well known in the art. However, it should be understood that the invention is not limited to this particular BSS algorithm. Other BSS algorithms can also be used, as will be understood by one skilled in the art. The focus of the invention is not on the particular BSS algorithm used, but rather on the unique use of the BSS algorithm to coherently combine widely separated apertures.

In the present invention, rather than using a BSS algorithm to separate signals from each other, it is used to coherently sum them together. The process involves combining two signals together from two separate apertures, where each of the signals has a relatively high S/N ratio as received at its respective aperture. This high S/N ratio is due to each aperture being separately controlled and pointed, outside the control of the BSS algorithm, at the direction of the signal source. Signal sorting of multiple signals is not performed at each aperture in the conventional manner which is normally associated with BSS processing. The BSS algorithm samples the signal environment from each aperture in real-time and slightly delayed in time. The sampled signals are then correlated to yield a set of optimum weights that when applied to each of the aperture signal streams coherently sums the signals together without any prior known information to their locations. The BSS algorithm is used to align the two signals in time by maximizing their respective S/N ratios without any a priori knowledge to where the individual apertures were pointed.

Significantly, the coherent combining performed by the BSS algorithm has a further advantage relating to scan loss. It will be recalled that scan loss occurs when an antenna array is directed in altitude or azimuth directions which represent deviations away from a boresight direction (broadside to each panel). The use of the BSS algorithm as described herein to perform the combining function fully compensates for the individual array panel scan loss. Consequently, the BSS combining arrangement described herein offers designers optimal combining that approaches theoretical limits for combining two or more apertures. It should be appreciated that conventional non-coherent methods of combining, by definition, are less efficient than the coherent combining described herein. Thus, the invention allows designers to avoid the need for larger arrays which are conventionally required to compensate for scan loss. The result is a less costly solution.

Yet another advantage of the present invention is that the adaptive processing used for coherent combining as described herein is independent of both frequency and bandwidth limitations. The coherent combining techniques described are scalable to work at any RF frequency, and over a variety of system bandwidths ranging from wide to narrow. In contrast, conventional methods that use transmission line phase matching techniques and are very difficult to implement, especially for very wideband systems and very high frequencies. The tolerances involved in such systems, and their tendency to be affected by environmental conditions can make coherent combining a very difficult task in conventional systems, and in any case, highly affected by conditions such as bandwidth and frequency.

Those skilled in the art will readily appreciate that the present invention can take the form of a computer program product on a computer-usable storage medium (for example, a hard disk or a CD-ROM). The computer-usable storage medium can have computer-usable program code embodied in the medium. The term computer program product, as used herein, refers to a device comprised of all the features enabling the implementation of the methods described herein. Computer program, software application, computer software routine, and/or other variants of these terms, in the present context, mean any expression, in any language, code, or notation, of a set of instructions intended to cause a system having an information processing capability to perform a particular function either directly or after either or both of the following: a) conversion to another language, code, or notation; or b) reproduction in a different material form.

All of the apparatus, methods and algorithms disclosed and claimed herein can be made and executed without undue experimentation in light of the present disclosure. While the invention has been described in terms of preferred embodiments, it will be apparent to those of skill in the art that variations may be applied to the apparatus, methods and sequence of steps of the method without departing from the concept, spirit and scope of the invention. More specifically, it will be apparent that certain components may be added to, combined with, or substituted for the components described herein while the same or similar results would be achieved. All such similar substitutes and modifications apparent to those skilled in the art are deemed to be within the spirit, scope and concept of the invention as defined.

We claim:

1. A method for coherently combining a plurality of widely separated apertures, comprising:
positioning a first antenna aperture at a first location spaced apart a distance with respect to at least a second location associated with at least a second antenna aperture;
selecting said distance to be a plurality of wavelengths at a predetermined operating frequency of said first antenna aperture and said second antenna aperture;
selectively directing toward a remote target a first antenna beam defined by said first antenna aperture and a second antenna beam defined by said second antenna aperture;
coherently combining a common RF signal received from said target at said first antenna aperture and at least said second antenna aperture in an adaptive process which eliminates a large aperture effect caused by said distance between said first and second antenna apertures.

2. The method according to claim 1, wherein said adaptive process is a blind source separation algorithm.

3. The method according to claim 2, further comprising generating an optimal steering vector for at least one of said first and second antenna apertures using said adaptive process.

4. The method according to claim 1, further comprising determining a time of arrival difference information of said common RF signal as received at said first antenna aperture and at least said second antenna aperture, and using said time of arrival difference information to time align said common RF signal as received at said first antenna aperture and at least said second antenna aperture.

5. The method according to claim 4, further comprising performing said time aligning step prior to said coherently combining step.

6. The method according to claim 1, wherein said adaptive process includes calculating at least one complex weight responsive to said common RF signal received at said first antenna aperture and said second antenna aperture, and applying said at least one complex weight to an output signal produced by at least one of said first antenna aperture and said second antenna aperture.

7. The method according to claim 6, further comprising summing said common RF signal as received at said first antenna aperture to said common RF signal as received at said second antenna aperture subsequent to applying said at least one complex weight.

8. The method according to claim 1, wherein said adaptive process includes eliminating at least one large aperture effect selected from the group comprising a very narrow main beam, deep nulls, and numerous grating lobes.

9. The method according to claim 1, further comprising selecting at least one of said first and second apertures to include a phased array.

10. The method according to claim 9, further comprising combining said common RF signal received by a plurality of elements forming said phased array prior to performing said coherently combining step.

11. The method according to claim 9, wherein said directing step comprises selectively controlling a plurality of elements comprising said phased array to electronically scan at least one of said first antenna beam and said second antenna beam.

12. The method according to claim 1, further comprising selecting said distance to be greater than 0.5 wavelengths at said predetermined operating frequency.

13. The method according to claim 1, further comprising selecting said distance to be greater than 100 wavelengths at said predetermined operating frequency.

14. The method according to claim 1, further comprising selecting said distance to be greater than 1000 wavelengths at said predetermined operating frequency.

15. The method according to claim 1, wherein said coherently combining step further comprises fully compensating for a scan loss attributable to each of said first and second antenna apertures.

16. The method according to claim 1, wherein said adaptive process is scalable to work at any RF frequency.

17. The method according to claim 1, wherein said adaptive process is scalable to work with both narrow and wide bandwidth signals.

18. A system for coherently combining RF signals from a plurality of widely separated apertures, comprising:
a first antenna aperture positioned at a first location;
at least a second antenna aperture positioned at a second location spaced apart a distance with respect to said first location, said distance comprising a plurality of wavelengths at a predetermined operating frequency of said first antenna aperture and said second antenna aperture;
an antenna position controller configured for directing toward a remote target at least a first antenna beam defined by said first antenna aperture and a second antenna beam defined by said second antenna aperture;
signal processing means for coherently combining an RF signal received from a common target at said first antenna aperture and at least said second antenna aperture in an adaptive process which eliminates a large aperture effect caused by said distance between said first and second antenna apertures.

19. The system according to claim 18, wherein said adaptive process is a blind source separation algorithm (BSS).

20. The system according to claim 19, wherein said signal processing means is further configured for generating an optimal steering vector for at least one of said first and second antenna apertures using said adaptive process.

21. The system according to claim 19, wherein said signal processing means is further configured for generating a time difference control signal determined based on a time of arrival difference information of said RF signal at said first antenna aperture and at least said second antenna aperture; and
wherein said system further comprises at least one time delay device responsive to said time difference control signal for time aligning said RF signal as received at said first antenna aperture and at least said second antenna aperture.

22. The system according to claim 21, further comprising a plurality of complex weight memories coupled to said processing means for storing a plurality of complex weights generated by said BSS algorithm.

23. The system according to claim 22, further comprising at least one multiplier coupled to an output of said time delay device and said complex weight memory for applying said complex weights to said RF signal received from said common source.

24. The system according to claim 23, a summing device coupled to each of said multipliers for summing an output of each said multiplier subsequent to applying said complex weights.

25. The system according to claim 19, wherein said signal processing means eliminates at least one large aperture effect selected from the group comprising a very narrow main beam, deep nulls, and numerous grating lobes.

26. The system according to claim 19, wherein at least one of said first and second apertures comprises a phased array.

27. The system according to claim 26, further comprising combiner means at said phased array for combining said common RF signal received by a plurality of elements forming said phased array.

28. The system according to claim 26, wherein said phased array is responsive to said antenna position controller for selectively controlling a plurality of elements comprising said phased array to electronically scan at least one of said first antenna beam and said second antenna beam.

29. The system according to claim 18, wherein said distance is greater than 0.5 wavelengths at said predetermined operating frequency.

30. The system according to claim 18, wherein said signal processing means is configured to fully compensate for a scan loss attributable to each of said first and second antenna apertures concurrently with performing said coherent combining.

31. The system according to claim 18, wherein said adaptive process is scalable to work at any RF frequency.

32. The system according to claim 18, wherein said adaptive process is scalable to work with both narrow and wide bandwidth signals.
